(19) United States
(12) Patent Application Publication
(10) Pub. No.: US 2026/0034650 A1
(43) Pub. Date: Feb. 5, 2026

(54) Door Hinge Pin Removal Tool

(71) Applicant: Jagasar Persad, Laporte, TX (US)

(72) Inventor: Jagasar Persad, Laporte, TX (US)

(21) Appl. No.: 18/794,851

(22) Filed: Aug. 5, 2024

(51) Int. Cl. B25B 27/04

(52) U.S. Cl. CPC B25B 27/04

(57) ABSTRACT

A door hinge pin removal tool generally comprises a handle, a tool head, and a pin punch structure. The pin punch structure includes a base portion and a punch portion. The punch portion includes a punch end section that has a maximum diameter less than an inner diameter of a door hinge knuckle. The base portion has a maximum diameter greater than an inner diameter of a door hinge knuckle. The punch portion is designed to taper in diameter from the base portion to the punch end section to provide greater stability and punching power and an automatic centering of the punch end section in a door hinge knuckle in a door hinge pin removal procedure.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to door hinge pin tools and more particularly pertains to a new door hinge pin removal tool for quickly and easily removing door hinge pins. Door hinge pins hold together to the two plates of a door hinge by insertion of the shaft of the door hinge pin into the door hinge knuckles. The door hinge pin has a head at the top for preventing the door hinge pin from sliding through the knuckles. Sometimes it is necessary to remove the door hinge pin to disconnect the door from the frame for repairs or replacement. There are many tools and techniques for removing door hinge pins. However, there are no such tools that provide both a prying and punching option with a centering function for easy removal of door hinge pins.

### (2) Description of Related Art including information disclosed under 37 CFR 1.97 and 1.98

The prior art relates to door hinge pin tools. The prior art, as best understood, does not disclose a door hinge pin removal tool that provides both a prying and punching option with a centering function for easy removal of door hinge pins.

### BRIEF SUMMARY OF THE INVENTION

An embodiment of the disclosure meets the needs presented above in a door hinge pin removal tool generally comprising a handle, a tool head, and a pin punch structure. The handle is elongated and includes a tool end and a gripping end designed to be manually gripped by a user. The tool head is disposed at the tool end and designed to engage with a head of a door hinge pin. The pin punch structure is mounted on and designed and disposed to extend from the handle. The pin punch structure includes a base portion connected to the handle and a punch portion extending from the base portion. The punch portion includes a punch end section having a maximum diameter less than an inner diameter of a door hinge knuckle to permit insertion of the punch end section into a door hinge knuckle to engage a bottom of a shaft of a door hinge pin to be removed from a door hinge. The base portion has a maximum diameter greater than an inner diameter of a door hinge knuckle. The punch portion is designed to taper in diameter from the base portion to the punch end section to provide greater stability and punching power and an automatic centering of the punch end section in a door hinge knuckle in a door hinge pin removal procedure.

Current door hinge pin removal tools usually have a rod structure that is basically the same size and shape as the shaft of a door pin, which presents some disadvantages. First, not all door hinge pins are the same diameter or size, so the rod structure may be too large to fit into the door hinge knuckle. Second, it is easy to misalign such tools, so that when they are struck with a hammer or hand or similar, the rod structure may simply strike against the knuckle, causing damage to the knuckle and possibly surrounding structures if the rod structure deflects and hits into the surrounding structures, such as a wall, the door frame, or the door itself. Third, the rods are relatively thin, so they are not as strong and do not transfer forces well. The present invention has a tapered design with a punch end section that is smaller than essentially any door hinge knuckle to guarantee at least some portion of the punch end section will fit into the door hinge knuckle. This design therefore overcomes the problem of fitting into the knuckle. It also addresses the problem of misalignment because the tapered end will automatically guide or center itself when driven into the knuckle. Finally, since it has a larger base combined with a tapered design, the pin punch structure has greater stability and strength and will transfer more force to the end for greater striking power.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a door hinge pin removal tool according to an embodiment of the disclosure.

FIG. 2 is a rear perspective view of an embodiment of the disclosure.

FIG. 3 is a front view of an embodiment of the disclosure.

FIG. 4 is a side view of an embodiment of the disclosure.

FIG. 5 is a view of an embodiment of the disclosure in use.

FIG. 6 is a view of an embodiment of the disclosure in use.

FIG. 7 is a view of an embodiment of the disclosure in use.

### DETAILED DESCRIPTION OF THE INVENTION

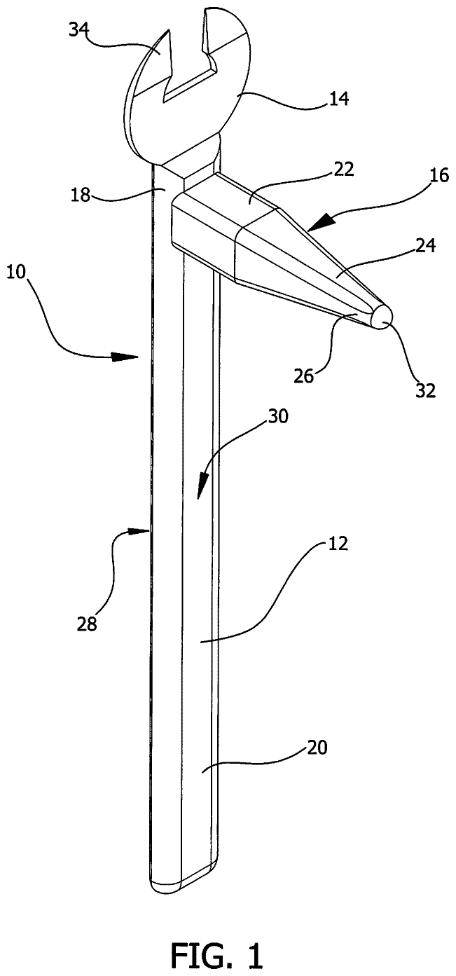

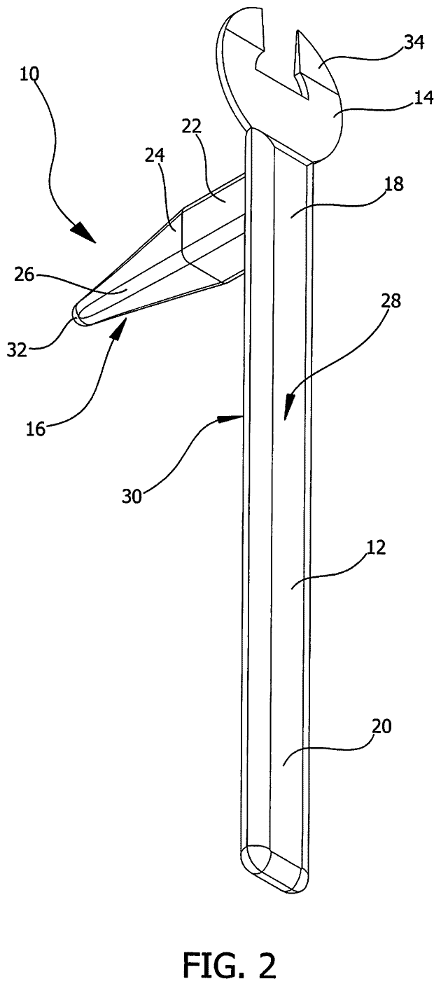

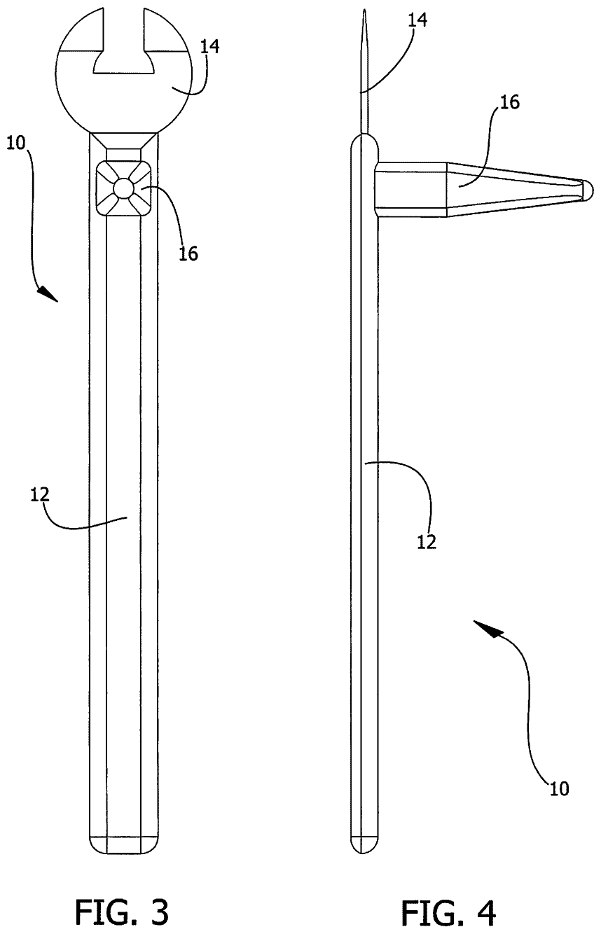

With reference now to the drawings, and in particular to FIGS. 1 through 7 thereof, a new door hinge pin removal tool embodying the principles and concepts of an embodiment of the disclosure and generally designated by the reference numeral 10 will be described.

As best illustrated in FIGS. 1 through 7, the door hinge pin removal tool 10 generally includes a handle 12, a tool head 14, and a pin punch structure 16. The handle 12 is elongated and includes a tool end 18 and a gripping end 20 designed to be manually gripped by a user. The tool head 14 is positioned at the tool end 18 and is designed to engage with a head 66 of a door hinge pin 64. The pin punch structure 16 is mounted on and designed and positioned to extend from the handle 12. The pin punch structure 16 includes a base portion 22 connected to the handle 12 and a punch portion 24 extending from the base portion 22. The punch portion 24 includes a punch end section 26 having a maximum diameter less than an inner diameter of a door hinge knuckle 62 to permit insertion of the punch end section 26 into the door hinge knuckle 62 to engage a bottom of a shaft 68 of the door hinge pin 64 to be removed from a door hinge 60. The base portion 22 has a maximum diameter greater than an inner diameter of the door hinge knuckle 62. The punch portion 24 is designed to taper in diameter from the base portion 22 to the punch end section 26 to provide greater stability and punching power and an automatic centering of the punch end section 26 in the door hinge knuckle 62 in the door hinge pin 64 removal procedure.

In accordance with at least one possible embodiment, the handle 12 is substantially flat or planar and includes a strike side 28 and a punch side 30. The pin punch structure 16 is positioned to extend from and transverse to the punch side 30. The strike side 28 is designed to be struck by a tool or a hand of a user to drive the pin punch structure 16 and thus the punch end section 26 into the door hinge pin 64 to axially move and dislodge the door hinge pin 64 from the door hinge 60.

In accordance with at least one possible embodiment, the punch end section 26 includes a rounded tip 32 designed to minimize damage to the door hinge knuckle 62 or the door hinge pin 64 upon insertion or striking. The rounded tip 32 also aids in the centering of the punch end section 26 into the door hinge knuckle 62.

In accordance with at least one possible embodiment, the pin punch structure 16 is positioned at the tool end 18 of the handle 12 adjacent the tool head 14.

In accordance with at least one possible embodiment, the tool head 14 is substantially flat to permit insertion under a head 66 of the door hinge pin 64 to permit a user to lift the door hinge pin 64 out of the door hinge 60. The tool head 14 also includes a recess designed to be placed around the shaft 68 of the door hinge pin 64 upon insertion of the tool head 14 under the head 66 of the door hinge pin 64.

In accordance with at least one possible embodiment, the tool head 14 includes a wedge-like end portion 34 designed to permit insertion under a head 66 of the door hinge pin 64 close to the door hinge knuckle 62.

In accordance with at least one possible embodiment, the base portion 22 is shaped as a rectangular prism and the punch portion 24 is shaped as an elongated pyramid. In accordance with at least one possible embodiment, the base portion 22 is shaped as a cylinder and the punch portion 24 is shaped as an elongated cone. While one shape style is shown in the figures, other tapered designs and shapes are within the scope of the disclosure.

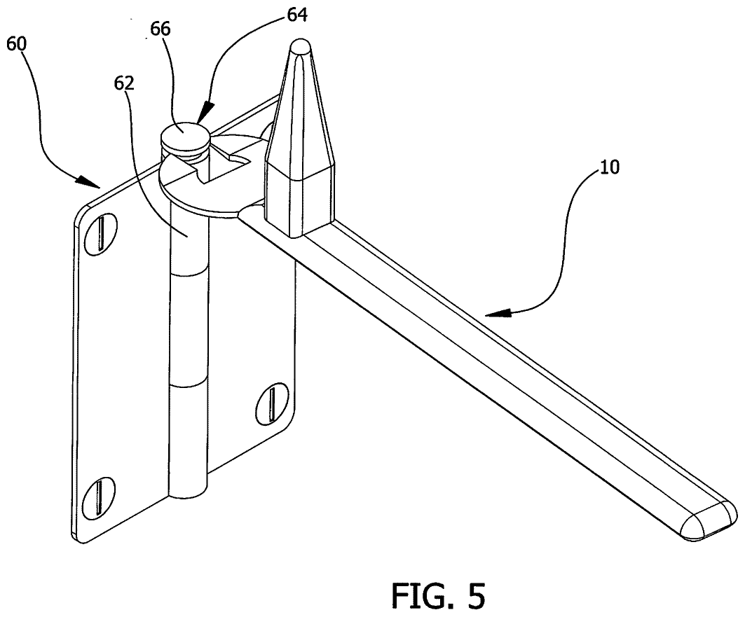

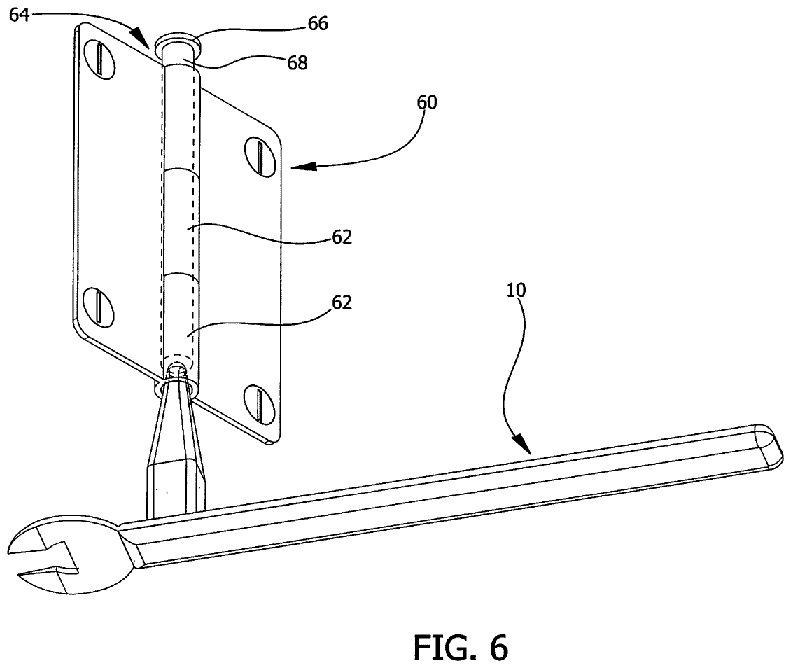

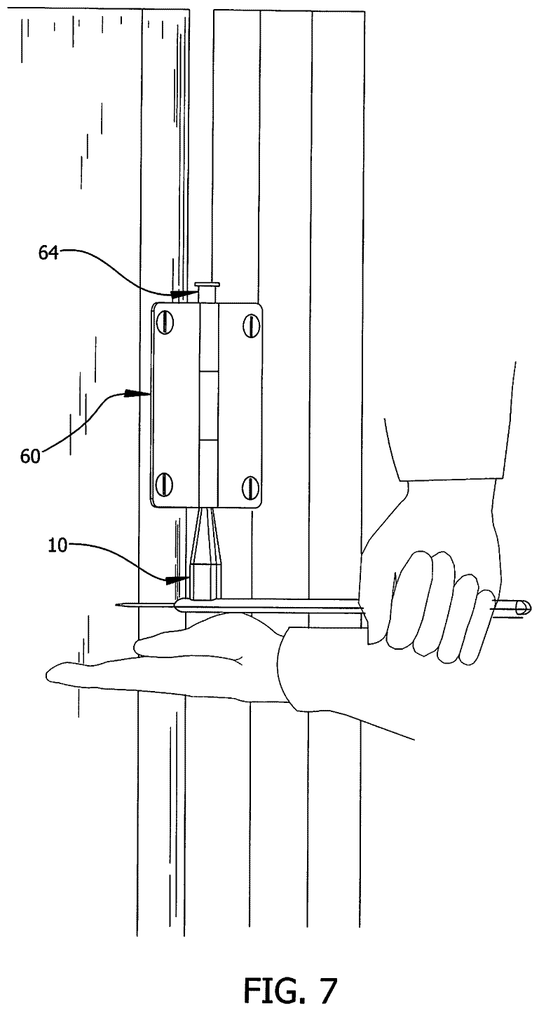

Use of the door hinge pin removal tool 10 is shown in FIGS. 5, 6, and 7. FIG. 5 shows how the tool head 14 can be inserted under the door hinge pin head 66 to lift the door hinge pin 64 out of the knuckle 62. FIG. 6 shows how the pin punch structure 16 can be inserted into the door hinge knuckle 62 to dislodge the door hinge pin 64. FIG. 7 shows how a user can strike the strike side 28 of the door hinge pin 64 removal tool 10 to cause the dislodging of the door hinge pin 64, which can be done with either the palm of the hand or a fist, or possibly with another tool, such as a hammer. Regardless of the method, the design of the door hinge pin removal tool 10 provides good stability and control in addition to the automatic centering effect caused by the tapered design of the pin punch structure 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items 10 following the word are included, but items not specifically mentioned are not excluded. A reference to an element by the indefinite article “a” does not exclude the possibility that more than one of the element is present, unless the context clearly requires that there be only one of the elements.

I claim:

1. A door hinge pin removal tool comprising:
a handle being elongated and comprising a tool end and a gripping end configured to be manually gripped by a user;
a tool head being disposed at said tool end and configured to engage with a head of a door hinge pin;
a pin punch structure being mounted on and configured and disposed to extend from said handle;
said pin punch structure comprising a base portion connected to said handle and a punch portion extending from said base portion;
said punch portion comprising a punch end section having a maximum diameter less than an inner diameter of a door hinge knuckle to permit insertion of said punch end section into a door hinge knuckle to engage a bottom of a shaft of a door hinge pin to be removed from a door hinge;
said base portion having a maximum diameter greater than an inner diameter of a door hinge knuckle; and
said punch portion being configured to taper in diameter from said base portion to said punch end section to provide greater stability and punching power and an automatic centering of said punch end section in a door hinge knuckle in a door hinge pin removal procedure.

2. The door hinge pin removal tool of claim 1, wherein:
said handle is substantially flat or planar and comprises a strike side and a punch side;
said pin punch structure is disposed to extend from and transverse to said punch side; and
said strike side is configured to be struck by a tool or a hand of a user to drive said pin punch structure and thus said punch end section into a door hinge pin to axially move and dislodge a door hinge pin from a door hinge.

3. The door hinge pin removal tool of claim 2, wherein said punch end section comprises a rounded tip configured to minimize damage to a door hinge knuckle or a door hinge pin upon insertion or striking.

4. The door hinge pin removal tool of claim 3, wherein said pin punch structure is disposed at said tool end of said handle adjacent said tool head.

5. The door hinge pin removal tool of claim 4, wherein:
said tool head is substantially flat to permit insertion under a head of a door hinge pin to permit a user to lift a door hinge pin out of a door hinge; and
said tool head comprises a recess configured to be placed around a shaft of a door hinge pin upon insertion of said tool head under a head of a door hinge pin.

6. The door hinge pin removal tool of claim 5, wherein said tool head comprises a wedge-like end portion configured to permit insertion under a head of a door hinge pin close to a door hinge knuckle.

7. The door hinge pin removal tool of claim 6, wherein:
said base portion is shaped as a rectangular prism; and
said punch portion is shaped as an elongated pyramid.

8. The door hinge pin removal tool of claim 6, wherein:
said base portion is shaped as a cylinder; and
said punch portion is shaped as an elongated cone.

9. The door hinge pin removal tool of claim 1, wherein said punch end section comprises a rounded tip configured to minimize damage to a door hinge knuckle or a door hinge pin upon insertion or striking.

10. The door hinge pin removal tool of claim 1, wherein said pin punch structure is disposed at said tool end of said handle adjacent said tool head.

11. The door hinge pin removal tool of claim 1, wherein:
said tool head is substantially flat to permit insertion under a head of a door hinge pin to permit a user to lift a door hinge pin out of a door hinge; and
said tool head comprises a recess configured to be placed around a shaft of a door hinge pin upon insertion of said tool head under a head of a door hinge pin.

12. The door hinge pin removal tool of claim 11, wherein said tool head comprises a wedge-like end portion configured to permit insertion under a head of a door hinge pin close to a door hinge knuckle.

13. The door hinge pin removal tool of claim 1, wherein:
said base portion is shaped as a rectangular prism; and
said punch portion is shaped as an elongated pyramid.

14. The door hinge pin removal tool of claim 1, wherein:
said base portion is shaped as a cylinder; and
said punch portion is shaped as an elongated cone.
